(19) United States
(12) Patent Application Publication
(10) Pub. No.: US 2017/0367366 A1
(43) Pub. Date: Dec. 28, 2017

(54) COFFEE COMPOSITIONS AND USES THEREOF

(71) Applicant: NESTEC S.A., Vevey (CH)

(72) Inventors: Matthieu Pouzot, Lausanne (CH); Gerhard Niederreiter, Savigny (CH); Mathieu Murith, Bulle (CH); Stephan Palzer, Lausanne (CH); Fabrice Desbois, Thonon-les-bains (FR); Luigi Poisson, Courgevaux (CH); Christine Haider, Lausanne (CH); lennart Fries, Lausanne (CH)

(21) Appl. No.: 15/538,127

(22) PCT Filed: Dec. 17, 2015
(86) PCT No.: PCT/EP2015/080351

§ 371 Date: Jun. 20, 2017

(30) Foreign Application Priority Data
Dec. 22, 2014 (EP) 14199900.3

(51) Int. Cl. A23F 5/08; A23F 5/02; A23F 5/04; A23F 5/14

(52) U.S. Cl. CPC A23F 5/08; A23F 5/14; A23F 5/02; A23F 5/04

(57) ABSTRACT

The present invention relates to processes for providing coffee compositions with enhanced coffee aromas. In addition the invention relates to the use of such coffee compositions for making capsules for beverage dispensers.

### TECHNICAL FIELD OF THE INVENTION

The present invention relates to processes for providing coffee compositions. In particular the present invention relates to beverages containing micronized green coffee bean particles suspended in oil which were roasted in oil phase.

The present invention relates to the use of above roasted green coffee in creamers, beverage powders, ready-to-drink liquid beverage preparations, or beverage capsules suitable for the production of a beverage.

### BACKGROUND OF THE INVENTION

Coffee aroma is responsible for all coffee flavor attributes other than the mouthfeel and sweet, salt, bitter, and sour taste attributes that are perceived by the tongue. Therefore coffee aroma is the most important attribute to specialty coffee. Even instant coffee has the components responsible for stimulation of our aroma receptors. The difference, however, is that instant coffee lacks most of the aromatic volatile compounds causing a dramatic decrease in the overall coffee flavor.

Prior art methods relate to roasting whole green beans by dry heating prior to grinding and micronization of coffee particles. This process has a disadvantage of losing aroma during the process. Thus there is a need for a coffee composition that can result in an enhanced intense aroma profile. An improved aroma release would be a great benefit, and in particular a more efficient and/or reliable process for providing compositions with improved aromas would be advantageous.

The present invention relates to micronization of green coffee in full dry state—before suspension into oil and roasting of micronized suspension. The advantage of this process is that there is full protection, highly fresh roasted aroma, fully captured and directly protected from degradation since roasting process is directly done into oil.

Coffee compositions are also added to capsules for the preparation of a beverage in specifically designed brewing machines already exists on the market Patent EP 0512468 relates to such a cartridge. Such capsules may be used for preparing coffee beverages using beverage dispensers such as Nescafe Dolce Gusto® machine.

There is a need to produce capsules containing such beverage powder that has a long shelf life and better solubility.

### SUMMARY OF THE INVENTION

One Aspect of the invention relates to a process for providing a coffee composition, the process comprising
a) mixing an oil component with green coffee bean and grinding the coffee bean in oil thereby providing a composition comprising micronized coffee incorporated in the oil component; and
b) roasting the micronized component.

Another aspect of the invention relates to a coffee composition obtainable by the above process.

Further aspects of the present invention relate to use of the coffee compositions for producing a RTD beverage, creamer, coffee mix, cocoa malt beverage, chocolate, bakery or culinary product.

The present invention will be described in more detail in the following.

### BRIEF DESCRIPTION OF FIGURES

FIG. 1 shows test samples for micronized coffee particles subsequently roasted in oil phase. A heat treatment in the microwave leads to an advancing colour development and browning just as in a conventional roasting process. The applied temperatures for the heat treatment in the microwave lay between 180° C. and 220° C. Color development and browning occurred due to roasting of green coffee bean in oil by means of microwave heating. Higher roasting temperatures create darker color.

FIG. 2 shows heat treatment of micronized green coffee samples in oil using a heated oil bath at 220° C.

FIG. 2 displays an alternative way of heat treating the green coffee been dispersed in oil and filled into a test tube, by tempering it in a heated oil bath. Whereas FIG. 3 highlights the difference of the micronized green coffee bean in oil before and after the heat treatment described in FIG. 2.

FIG. 3: A) Dried micronized green coffee bean in oil; A*) Sample A after heat treatment of 14 minutes at 220° C.

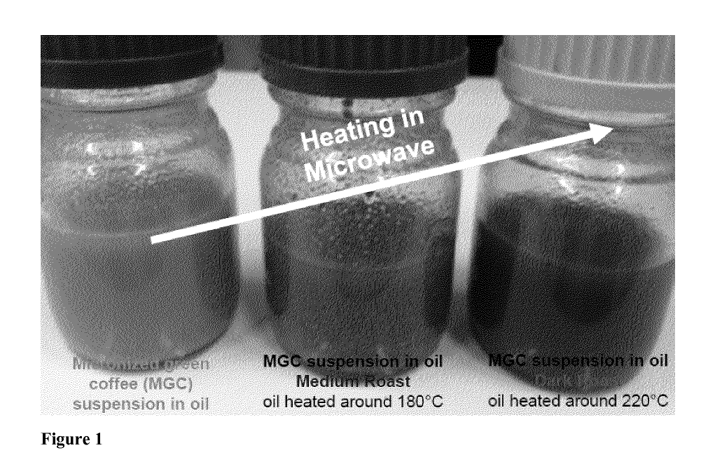

### DETAILED DESCRIPTION OF THE INVENTION

As mentioned above, the present invention relates to process for providing coffee compositions with improved solubility and having an enhanced taste and/or aroma profile. Thus, an aspect of the present invention relates to a process for providing a coffee composition, the process comprising
a) mixing in a first mixing step an oil component with green coffee bean and grinding the coffee bean in oil thereby providing a first composition comprising micronized coffee incorporated in the oil component; and
b) roasting the micronized component.

In another embodiment the process of the present invention further comprises the steps of
providing a aqueous component comprising milk proteins, plant proteins or combinations thereof,
mixing in a second mixing step the first roasted micronized composition with the second composition and
Homogenising the composition thereby providing an oil-in-water emulsion.

In one embodiment, the above process comprises further step f) Drying above mentioned oil-in-water emulsion into a powder.

In one embodiment of the present invention, the roasting is a process of heating the oil component containing micronized green coffee composition to 160-250° C. for possibly 2-15 minutes. In one embodiment of the present invention, the roasting is a process of heating the oil component containing micronized green coffee composition to 160-250° C. for possibly 2-30 minutes. In one embodiment, heating the oil component is done at 160-180° C. for 8-15 minutes. In one embodiment, heating the oil component is done at 160-180° C. for 8-15 minutes. In one embodiment, heating the oil component is done at 160-250° C. for 8-30 minutes. Such roasting step can be done using a microwave, any heat tubular exchanger or any frying or cooking equipment.

Micronized green coffee particles (MGC) can be obtained from different and versatile range of micronization technologies such as roller grinding, jet milling, cryo milling and then suspended in to oil. Or direct suspension of MGC into oil can be obtained by bead milling into oil of coarsely ground green coffee particles.

Some micronization technologies such as jet milling of roasted bean are not preferred due to impact on aroma loss. In the present process there is no need for nitrogen protection of the green coffee during milling as done with other currently used technologies. Using green coffee only at the 1^{st} step of jet milling micronization is then feasible with no impact on aroma loss, since the roasting is done in oil at a second stage of the process—fully decoupled. Thus the advantage of the present invention is immediate capture of coffee aroma into oil, better recovery and provides maximum protection of fresh aroma. Since aroma is generated directly in oil this aroma is protected from any disadvantageous interaction with oxygen or any aroma compromising environment. Furthermore, oil is also an excellent medium that enables to maximize coffee aroma recovery at direct point of generation, i.e. at roasting step. Roasting level is also better controlled, less uneven roasting and faster due to size of micronized green coffee particles compared to using whole green coffee beans.

Thus, an object of the present invention relates to processes for providing coffee compositions with improved aroma profiles.

The order of mixing the different components may vary. Preferably, the oil phase and an aqueous phase are prepared separately. Emulsifiers are usually mixed into the oil but may also be added to the aqueous phase. Protein and other milk proteins such as creamer components are dissolved in the aqueous phase. The two phases are then mixed and homogenized to produce an emulsion, which can be used in liquid form or dried. The coffee particles may be incorporated into (and milled in) only a part of the oil and additional oil may be added afterwards. Thus, in an embodiment one or more further oil components are added after step e), such as before pasteurization and/or drying.

The coffee particles are preferably micronized after addition to the oil (e.g. by milling), but the coffee particles may also be provided to the oil in a micronized form.

Emulsifiers are preferably added to the first composition in step a), but it may also be added in other steps. Thus, in an embodiment the one or more emulsifiers are added
to the first composition in step a); and/or
to the aqueous component in step c); and/or
during the mixing step c); and/or
during the homogenisation step d).

The coffee composition of the invention may comprise low molecular weight emulsifiers. By a low molecular weight emulsifier is meant an emulsifier with a molecular weight below 1500 g/mol. Emulsions are thermodynamically unstable, and the phases of an emulsion will separate with time. By an emulsifier is meant a compound that stabilises the interface between the two phases of the oil-in-water emulsion and reduces the rate of phase separation. In an embodiment the emulsifiers are selected from the group consisting monoglycerides, diglycerides, acetylated monoglycerides, sorbitan trioleate, glycerol dioleate, sorbitan tristearate, propyleneglycol monostearate, glycerol monooleate and monostearate, sorbitan monooleate, propylene glycol monolaurate, sorbitan monostearate, sodium stearoyl lactylate, calcium stearoyl lactylate, glycerol sorbitan monopalmitate, diacetylated tartaric acid esters of monoglycerides, lecithins, lysolecithins, succinic acid esters of mono- and/or diglycerides, lactic acid esters of mono- and/or diglycerides, lecithins, lysolecitins, proteins and sucrose esters of fatty acids, lecithin (e.g. soy lecithin, canola lecithin, sunflower lecithin, and/or safflower lecithin), lysolecithins, and combinations thereof.

The mixing step a) may be performed by different means. In an embodiment the first mixing step a) is done by milling to micronize the coffee component. In the present context the term “micronize” relates to a process wherein the particles are processed to particle sizes below 100 micrometers (μm), such as in the range 0.1-50 μm, such as in the range 1-30 μm, such as in the range 1-25 μm. Similar the term “micronized” relates to particles with an average particle size below 100 micrometers (μm), such as in the range 0.1-50 μm, such as in the range 1-25 μm, or such as in the range 1-100 μm. Milling is preferably performed in a ball mill by milling green coffee in oil or direct dry milling. In one embodiment of the invention, the first mixing step a) is done by milling to micronize the coffee component. The milling may be for instance a roller milling of coffee in oil or melted fat, jet milling or impact milling of coffee into oil.

The oil component of step a) may be selected from different sources. In one embodiment the oil component of step a) comprises oil selected from the group consisting of palm kernel oil, canola oil, soy bean oil, sunflower oil, safflower oil, cotton seed oil, palm oil, milk fat, corn oil, and/or coconut oil. The oil is preferably present in the creamer composition in an amount of at most about 50% (weight/weight), the amount of oil in the creamer composition may e.g. be between 1% and 40% (weight/weight), such as in the range 5-40%, such as in the range 10-40, such as in the range 5-30%, or such as in the range between 10-30%. In the present context when oil is included in the weight/weight percentages the % relates to the non-water part but including oil (solid content+oils). The total amount of oil component comprising micronized coffee therein in the aqueous composition may also vary. Thus, in yet a further embodiment the aqueous composition comprises at least 5% (w/w) of the oil component comprising micronized coffee therein, such as in the range 5-50%, such as 5-40%, such as 5-30%, such as in the range 5-20%, or such as in the range 5-15%. In another embodiment the aqueous composition comprises at least 20% (w/w) of the oil component comprising micronized coffee therein. It is to be understood that these weight % includes both the oil and the micronized coffee therein.

In the context of the present invention, mentioned percentages are weight/weight percentages of dry solids (on a dry matter basis) unless otherwise stated.

The process of the invention also includes the addition of a creamer component, preferably in an aqueous form. By a creamer composition/is meant a composition that is intended to be added to a food composition, such as e.g. coffee, to impart specific characteristics such as colour (e.g. whitening effect), flavour, texture, mouthfeel and/or other desired characteristics. Thus the coffee composition as provided by this invention can also be used as a creamer. The creamer component provided in step c) is in a liquid form, but the final creamer composition of the invention may be in a liquid form or in a powdered (dry) form. In the present context dried coffee is to be understood as having moisture content below 10%, preferably below 5% or more preferably below 3% water.

The creamer component may be any ingredient or combination of ingredients useful for inclusion in an aqueous composition. Thus, in an embodiment the aqueous component of step c) comprises a protein, a hydrocolloid, a buffering agent, and/or a sweetener.

The aqueous component preferably comprises protein in the range 0.5-15%, such as 1.5-10% such as 1.5-5% preferably between about 0.1-3% protein, such as between about 0.2-2% protein, more preferably between about 0.5% (weight/weight) and about 1.5% protein.

The protein may be any suitable protein, e.g. milk protein, such as casein, caseinate, and whey protein; vegetable protein, e.g. soy and/or pea protein; and/or combinations thereof. The protein is preferably sodium caseinate. The protein in the composition may work as an emulsifier, provide texture, and/or provide whitening effect. Too low levels of protein may reduce the stability of the liquid creamer. At too high protein levels the viscosity of the product may be higher than desired and too high for liquid processing.

The aqueous component may comprise a hydrocolloid. Hydrocolloids may help to improve physical stability of the composition. Suitable hydrocolloids may e.g. be carrageenan, such as kappa-carragenan, iota-carragenan, and/or lambda-carragenan; starch, e.g. modified starch; cellulose, e.g. microcrystalline cellulose, methyl cellulose, or carboxy-methyl cellulose; agar-agar, gelatine; gellan (e.g., high acyl, low acyl); guar gum; gum Arabic; kojac; locust bean gum; pectin; sodium alginate; maltodextrin; tracaganth; xanthan; or a combination thereof.

The aqueous component of the present invention may further include a buffering agent. The buffering agent can prevent undesired creaming or precipitation of the creamer upon addition into a hot, acidic environment such as coffee. The buffering agent can e.g. be monophosphates, diphosphates, sodium mono- and bicarbonates, potassium mono- and bicarbonates, or a combination thereof. Preferred buffers are salts such as potassium phosphate, dipotassium phosphate, potassium hydrophosphate, sodium bicarbonate, sodium citrate, sodium phosphate, disodium phosphate, sodium hydrophosphate, and sodium tripolyphosphate. The buffer may e.g. be present in an amount of about 0.1 to about 3% by weight of the creamer.

The aqueous component of the present invention may further include one or more additional ingredients such as flavors, sweeteners, colorants, antioxidants (e.g. lipid antioxidants), or a combination thereof. Sweeteners can include, for example, sucrose, fructose, dextrose, maltose, dextrin, levulose, tagatose, galactose, corn syrup solids and other natural or artificial sweeteners. Sugarless sweeteners can include, but are not limited to, sugar alcohols such as maltitol, xylitol, sorbitol, erythritol, mannitol, isomalt, lactitol, hydrogenated starch hydrolysates, and the like, alone or in combination. Usage level of the flavors, sweeteners and colorants will vary greatly and will depend on such factors as potency of the sweetener, desired sweetness of the product, level and type of flavor used and cost considerations. Combinations of sugar and/or sugarless sweeteners may be used. In one embodiment, a sweetener is present in the creamer composition of the invention at a concentration ranging from about 5-90% by weight of the total composition, such as in the range 20-90%, preferably such as 20-70%. In another embodiment, the sweetener concentration ranges from about 40% to about 60% by weight of the total composition. In a preferred embodiment the sweetener of step e) is glucose syrup.

In a preferred embodiment the aqueous component comprises sodium caseinate, dipotassium phosphate, sodium hexametaphosphate, trisodium citrate, sodium chloride and water. In yet an embodiment the aqueous component of step c) is a non-dairy creamer. When sodium caseinate is processed, it is so materially altered that both dairy scientists and government regulators no longer regard it as a true dairy substance. This is why sodium caseinate can be an ingredient in non-dairy products according to FDA's regulation.

Examples of typical aqueous compositions are presented in tables 1-3 below.

TABLE 1
Non-dairy creamers

| Ingredients | Non-dairy (NDC) | | |
|---|---|---|---|
| (in % by weight) | LOW FAT | REGULAR | HIGH FAT |
| Milk solids non-fat (SNF) | no | no | no |
| Casein/caseinate | 1.5-3.0 | 1.5-3.0 | 1.5-3.0 |
| Lactose/sweet whey | no | 110 | no |
| Glucose syrup | 80-90 | 50-60 | 40-50 |
| Milk fat | no | no | no |
| Vegetable fat | 10-20 | 30-35 | 40-45 |
| Emulsifiers | yes | yes | yes |
| Buffer salts | yes | yes | yes |
| Flavours | optional | optional | optional |
| Colorants | optional | optional | optional |
| Flowing agents | optional | optional | optional |
| Moisture | 1-3 | 1-3 | 1-3 |

TABLE 2
Filled dairy creamers

| Ingredients | Filled dairy (FDC) | | |
|---|---|---|---|
| (in % by weight) | LOW FAT | REGULAR | HIGH FAT |
| Milk solids non-fat (SNF) | 70-90 | 20-40 | 20-40 |
| Casein/caseinate | optional | optional | optional |
| Lactose/sweet whey | 0-10 | 20-40 | 20-40 |
| Glucose syrup | optional | optional | optional |
| Milk fat | no | no | no |
| Vegetable fat | 0-10 | 25-30 | 35-40 |
| Emulsifiers | no | no | no |
| Buffer salts | yes | yes | yes |
| Flavours | optional | optional | optionai |
| Colorants | optional | optional | optional |
| Flowing agents | optional | optional | optional |
| Moisture | 1-3 | 1-3 | 1-3 |

TABLE 3
Full dairy creamers

| Ingredients | |
|---|---|
| (in % by weight) | Full dairy |
| Milk solids non-fat (SNF) | 30-40 |
| Casein/caseinate | optional |
| Lactose/sweet whey | 0-40 |
| Glucose syrup | no |
| Milk fat | 15-30 |
| Vegetable fat | No |
| Emulsifiers | no |
| Buffer salts | yes |
| Flavours | optional |
| Colorants | optional |
| Flowing agents | optional |
| Moisture | 1-3 |

The skilled person may produce other variants of creamers. Thus, the above creamer compositions are mere examples of aqueous compositions.

The process may also include a pasteurizing step. Thus, in yet another embodiment the pasteurizing step is performed at a minimum temperature of 81° C. for at least 5 seconds. The coffee composition as obtained after the pasteurizing step can be used for making RTD beverages. The process may also include a drying step. Thus, in a further embodiment the drying step is performed by spray drying, vacuum band drying, roller drying or freeze drying. The coffee composition as obtained after the drying step can be used for making creamers for use in beverage industry for example as milk additive for coffee and tea beverage. The coffee composition after dry mixing may be used to make beverage powders such a chocolate/malt beverages, coffee mixes, bakery and culinary products for retail purposes. Such coffee composition may also be used for preparation of capsules to be used in a beverage dispenser.

As previously mentioned the coffee may also be in a dried form. Therefore in yet an aspect the invention relates to an oil-in-water emulsified dry coffee composition comprising
an oil component comprising micronized coffee incorporated therein; and
an aqueous component, e.g. comprising sodium caseinate.

The amount of micronized coffee may also be defined in relation to the amount of oil in which it is incorporated. Thus, in another embodiment the weight/weight ratio (or ratio by weight) between the amount of micronized coffee incorporated in the oil to the amount of oil is in the range 0.01:1-2:1, such as 0.05:1-2:1, such as 0.1:1-2:1, such as 0.1:1-1:1, such as 0.4:1-1:1, such as 0.6:1-1:1, such as 0.8:1-1, or such as 1:1.

In the context of the present invention, the terms “ratio by weight” “(weight/weight)” or “weight/weight ratio” refers to the ratio between the weights of the mentioned compounds.

It is to be understood that the coffee compositions of the invention may both be in a dry format (moisture content below 10%, preferably below 5%, and even more preferably below 3%) or in a liquid state.

Examples of preferred coffee compositions of the invention include:

A coffee composition according to the invention comprising
1-50% (w/w) of the oil component comprising micronized coffee incorporated therein, wherein the micronized coffee constitutes 2.5-70% of the total weight of the oil component comprising micronized coffee incorporated therein; and
one or more protein components, e.g. including sodium caseinate.

A coffee composition according to the invention comprising
1-50% (w/w) of the oil component comprising micronized coffee incorporated therein, wherein the micronized coffee constitutes 2.5-70% of the total weight of the oil component comprising micronized coffee incorporated therein; and
10-50% (w/w) of one or more protein components, e.g. including sodium caseinate.

A coffee composition according to the invention comprising
1-50% (w/w) of the oil component comprising micronized coffee incorporated therein, wherein the micronized coffee constitutes 2.5-70% of the total weight of the oil component comprising micronized coffee incorporated therein;
10-50% (w/w) of one or more protein components, e.g. including sodium caseinate; and
10-70% (w/w) of a sugar source, such as glucose syrup.

It should be noted that embodiments and features described in the context of one of the aspects of the present invention also apply to the other aspects of the invention.

All patent and non-patent references cited in the present application, are hereby incorporated by reference in their entirety.

The invention will now be described in further details in the following non-limiting examples.

### EXAMPLES

### Example 1

### Process for Providing a Ready-to-Drink (RTD) Beverage

### Methods

Green coffee bean were coarsely ground, then mixed with pre-heated palm kernel oil and micronized using a bead mill (Hosokawa Alpine Hydro-Mill 90 AHM, T=65° C., zirconium oxide bead 1.7/1.9 mm, 3000 RPM, TS25).

After one passage through the mill the size distribution of the micronized particles is characterized by a d_{90,3} of 25 μm, i.e 90% of the mass belongs to particles with a diameter smaller than 25 micrometers.

The suspension of MGC into FHPKO melted was then passed through heat tubular exchanger Actini with residence time

a) 12 min at temperature 180° C. to obtain a medium roast color and
b) 4 min residence time at 230° C. to obtain a dark roast color.

Roasting occurred leading to development of Coffee aroma.

In parallel skim milk (95%) and sugar (5%) were mixed and stirred in a vessel at 50° C.

Both the oily and the aqueous preparation were then mixed and stirred at 50° C. The final mix was pre-heated (80° C.), subjected to UHT treatment by direct steam injection (APV-HTST at 145° C. during 5 sec), flash-cooled to 80° C. and homogenized (APV-HTST).

Alternatively the suspension of MGC roasted into oil was added, after roasting occurred, into another composition containing 2-5% of coffee extract, and 13% sugar. The final mix was pre-heated (80° C.), subjected to UHT treatment by direct steam injection (APV-HTST at 145° C. during 5 sec), flash-cooled to 80° C. and then cooled to 20° C. before filling into can.

### Aroma Test

Surprisingly after addition of this MGC particles roasted in oil into both of aqueous composition the aroma was found to be enhanced with more freshness and higher coffeeness perceived in sensory evaluation compared to simple addition of micronized roasted coffee particles into RTD aqueous compositions.

### Example 2

### Process for Providing a Creamer

Green coffee beans were coarsely ground, then mixed with pre-heated palm kernel oil and micronized using a wet bead mill (Hosokawa Alpine Hydro-Mill 90 AHM, T=65° C., zirconium oxide bead 1.7/1.9 mm, 3000 RPM, TS25).

After one passage through the mill the size distribution of the micronized particles is characterized by a d_{90,3} of 25 μm, i.e 90% of the mass belongs to particles with a diameter smaller than 25 micrometers.

The suspension of MGC into FHPKO melted was then passed through heat tubular exchanger Actini with residence time

a) 12 min at temperature 180° C. to obtain a medium roast color
b) and b) 4 min residence time at 230° C. to obtain a dark roast color.

Roasting occurred leading to development of Coffee aroma.

In parallel glucose syrup, buffer salts and Na caseinate were mixed and stirred in a vessel at 65° C.

Both the oily and the aqueous preparation were then mixed and stirred at 50° C. The final mix was pre-heated (80° C.), subjected to UHT treatment by direct steam injection (APV-HTST at 145° C. during 5 sec), flash-cooled to 80° C. and homogenized (APV-HTST) The final emulsion mix is then homogeneised and spray dried into a drying tower. A powder creamer containing freshly roasted MGC is obtained

Surprisingly like for case of example 1, after addition of this MGC particles roasted in oil into both of aqueous composition the aroma was found to be enhanced with more freshness and higher coffeeness perceived in sensory evaluation compared to simple addition of micronized roasted coffee particles into creamer oil.

### Example 3

### Process for Providing a Hot Coffee Mix Beverage on Bench Scale

### Methods

Green coffee beans were cooled down with liquid nitrogen and then coarsely milled in a Ditting grinder to a d_{90,3} of 225 μm, i.e 90% of the mass belongs to particles with a diameter smaller than 225 micrometers. Afterwards, the milled green coffee bean was dried in an oven at 90° C. during 14 hours.

The dried milled green coffee bean was subsequently mixed with pre-heated palm kernel oil (1 part green coffee mixed into 2 parts of oil) and micronized in batch mode using a bead mill (Retsch, Planetary Ball Mill PM 100 CM, T=65° C., zirconium oxide bead 2.0 mm, 500 RPM).

After two times 30 minutes of milling under these conditions, the size distribution of the micronized particles of green coffee is characterized by a d_{90,3} of 35 μm, i.e 90% of the mass belongs to particles with a diameter smaller than 35 micrometers.

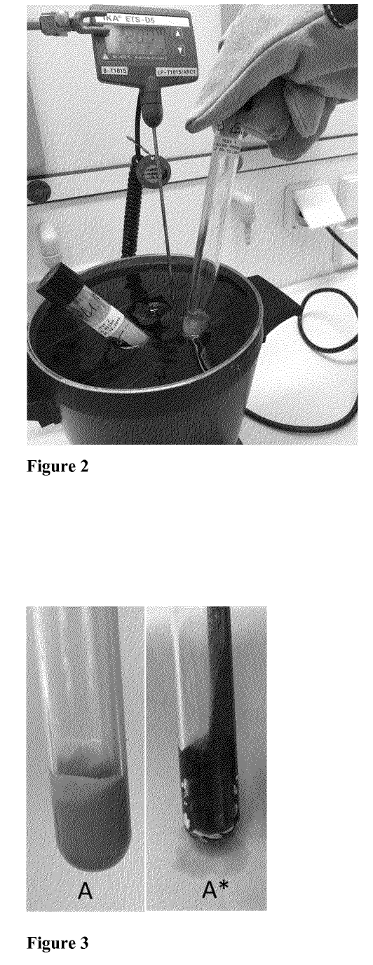

6 grams of the suspension of MGC into FHPKO melted were then filled into a test tube. After sealing the tube with a lid, it was put into a heated oil bath with a temperature adjusted to 220° C. for 14 minutes (FIG. 2). During this time, browning of the micronized green coffee sample occurred (FIG. 3). The aromas in the headspace of the test tube above the aromatized oil and the heat treated micronized coffee were evaluated by sniffing. Coffee notes could be perceived as well as complex aromas beyond that like, for example, popcorn and roasty aromas.

In parallel, two coffee mix powders (Reference and Base) were reconstituted in hot water at 85° C. The Reference contained Sucrose, maltodextrin, pure soluble coffee, FHPKO and micronized, but conventionally roasted coffee. The Base consisted of the same ingredients apart from the micronized roasted coffee and a smaller quantity of FHPKO was added. To make up for the reduced oil content and the missing micronized roasted coffee, the heat treated micronized coffee in oil (Sample A* in FIG. 3) was added to the base to create Mix A and to reach equal fat and coffee solids levels as in the Reference.

### Aroma Test

Surprisingly, after addition of MGC particles heat treated in oil into Mix A, this coffee mix showed stronger, more complex and fresher aromas than could be perceived for the Reference containing conventionally roasted micronized coffee. Even additional notes going into the direction of sweet, roasty, popcorn and caramel could be detected in mix A in the sensorial test.

### Aroma Analysis

The relative amounts (in %) of 22 flavour compounds were determined in the heat treated coffee-in-oil component (prototype Sample A*) of this invention as well as in a micronized roasted coffee in oil reference (set as 100% reference).

### Sample Preparation

The coffee-in-oil mixtures were heated to 60° C. to melt the oil matrix, and 0.5 g of the mixture were provided into silanised glass vials (20 ml) that were sealed (standard vials used for headpsace/SPME analysis).

### Extraction of Aroma

The coffee-in-oil samples were equilibrated for 60 min. at 20° C. in the sealed vials and the aroma compounds were then extracted from the headspace during 30 min. at 60° C. using Solid Phase Micro Extraction (SPME; 2 cm fibre coated with PDMS/DVB/Carboxen). Aroma compounds were thermally desorbed at 240° C. and injected into a GC/MS apparatus.

### GC/MS Analysis

The injected volatiles were separated on a DB-624 UI (Agilent) column using the following temperature program on the GC oven (Trace GC Ultra, Thermo Scientific): 40° C. isotherm for 6 min., at 6° C./min. to 180° C., than at 10° C./min to 250° C., finally 250° C. isotherm for 5 min. The mass spectrum was recorded at 70 eV (EI mode) using a Quadrupol mass spectrometer (ISQ, Thermo Scientific).

### Data Consolidation

Data were consolidated by means of Xcalibur software (Thermo Scientific). The peak areas of each single analyte was corrected to the amount of coffee matrix, and then converted to relative concentrations in % using the analyte peak of the MRC-in-oil product as 100% reference. The relative concentrations of aroma classes were obtained by averaging the respective single components of the class.

### Results

The results in Table 4 reveal significantly higher levels of key odorants in the micronized green coffee heat treated in oil (Sample A*). Particularly important coffee marker such as 2-furfurylthiol is found 4 times higher in the invention product as compared to the micronized roasted coffee sample. Freshness markers such as the aldehydes, diketones and sulphur compounds are up to 3 times higher, and phenols (spicy, phenolic) are around 20 times increased in the invention sample. Roasty and popcorn smelling components like 2-acetylthiazol, 2-acetylpyrazine and 2-acetylpyridine are found in average about 4 to 8 times higher in the heat treated MGC-in-oil sample as compared to the reference product. Most surprising impact is shown for caramel-like smelling furaneol with an increase of more than 500 times in the invention sample Sample A*. Earthy and roasty smelling pyrazines and bread-like smelling furfuryl compounds are about 1.7 to 20 times higher in the invention product as compared to the reference. The overall aroma content (average of relative concentrations of all 22 aroma compounds) in the invention product Sample A* is more than 30 times that of the reference coffee-in-oil sample.

TABLE 4
Relative concentrations of key aroma compounds [%]
in reference and invention product (Sample A*)

| | concentration [%] in coffee- | |
|---|---|---|
| | in-oil products | |
| | Reference | Sample A* |
| aroma compound (odorant group) | (MRC/oil) | (MGC/oil) |
| 2-methylpropanal | 100% | 133% |
| 3-methylbutanal | 100% | 141% |
| Aldehydes | 100% | 137% |
| methanethiol | 100% | 179% |
| 2-furfurylthiol | 100% | 417% |
| Sulfur compounds | 100% | 298% |
| 2,3-butanedione | 100% | 248% |
| 2,3-pentanedione | 100% | 278% |
| Diketones | 100% | 263% |
| 2-ethyl-3,6-dimethylpyrazine | 100% | 156% |
| 2-ethyl-3,5-dimethylpyrazine | 100% | 178% |
| Alkyl pyrazines | 100% | 167% |
| furfural | 100% | 1120% |
| 5-methylfurfural | 100% | 426% |
| furfuryl alcohol | 100% | 167% |
| furfuryl acetate | 100% | 2007% |
| Furfuryl compounds | 100% | 930% |
| 2-acetylthiazol | 100% | 427% |
| 2-acetylpyrazine | 100% | 841% |
| 2-acetylpyridine | 100% | 758% |
| N-heterocycles (w/o alkyl pyrazines) | 100% | 675% |
| furaneol | 100% | 53768% |
| maltol | 100% | 3046% |
| 2-hydroxy-3-methyl-2-cyclopentene-1-one | 100% | 739% |
| 3-ethyl-2-hydroxy-2-cyclopentene-1-one | 100% | 516% |
| Enolones | 100% | 14517% |
| guaiacol | 100% | 483% |
| 4-ethylguaiacol | 100% | 559% |
| 4-vinylguaiacol | 100% | 4842% |
| Phenols | 100% | 1961% |
| Overall content of aroma compounds | 100% | 3247% |

1. A process for providing a coffee composition, the process comprising
a) mixing an oil component with green coffee bean and grinding the coffee bean in oil thereby providing a composition comprising micronized coffee incorporated in the oil component; and
b) roasting the micronized component.

2. The process of claim 1 comprising the steps of:
mixing an aqueous component comprising milk proteins, plant proteins or combinations thereof; and
homogenising the composition thereby providing an oil-in-water emulsion

3. The process of claim 2, wherein the second composition is a milk protein and wherein the milk protein comprises sodium caseinate.

4. The process according to claim 1, wherein the process comprises the further steps of:
adding a bulking and/or a sweetener agent(s) to the oil-in-water emulsion; and
pasteurizing the oil-in-water emulsion.

5. The process according to claim 4, wherein the bulking agent comprises maltodextrin and the sweetener is selected from the group consisting of sugar, combination of carbohydrates and fibers.

6. The process according to claim 1, wherein the process comprises further steps of:
drying the oil-in-water emulsion; and
providing a coffee composition.

7. The process according to claim 1, wherein one or more emulsifiers are added:
to the first composition in step a); and/or
to the aqueous component in step c); and/or
during the mixing step c); and/or
during the homogenisation step e).

8. The process according to claim 1, wherein the first mixing step a) is done by milling to micronize the coffee component.

9. The process according to claim 1, wherein the roasting the micronized component comprises a process of heating the oil component in micronized coffee composition to 160-250° C. for 8-15 minutes.

10. The process of claim 9, wherein heating the micronized coffee in the oil component uses a microwave or heat tubular exchanger actini.

11. The process according to claim 1, wherein the weight/weight ratio between the amount of coffee incorporated in the oil and the amount of oil is in the range 0.01:1-2:1.

12. The process according to claim 11, comprising at least 5% (w/w) of the oil component comprising micronized coffee therein.

13. A coffee composition obtainable according to the process of claim 1.

14. A form for producing a product selected from the group consisting of RTD beverage, creamer, coffee mix, cocoa malt beverage, chocolate, bakery and a culinary product comprising the steps of
a) mixing an oil component with green coffee bean and grinding the coffee bean in oil thereby providing a composition comprising micronized coffee incorporated in the oil component; and
b) roasting the micronized component and using the resultant coffee product to produce the product.

15. The coffee composition of claim 13 wherein the coffee composition is in a form for use in the preparation of capsules to be used in a beverage dispenser.
